(19) United States
(12) Patent Application Publication
(10) Pub. No.: US 2025/0340699 A1
(43) Pub. Date: Nov. 6, 2025

(54) Sulfonated polyphenylene (phenylene) ether random copolymer, preparation method and application thereof

(71) Applicants: Hsu-Feng Lee, Nantou County (TW); Wei-Ting Liu, Nantou County (TW)

(72) Inventors: Hsu-Feng Lee, Nantou County (TW); Wei-Ting Liu, Nantou County (TW)

(21) Appl. No.: 19/060,641

(22) Filed: Feb. 22, 2025

(30) Foreign Application Priority Data
Mar. 15, 2024 (TW) 113109807

(51) Int. Cl. C08G 65/48; C08G 65/40

(52) U.S. Cl. CPC C08G 65/48; C08G 65/40; C08G 2650/28

(57) ABSTRACT

The present invention discloses sulfonated polyphenylene (phenylene) ether random copolymer, preparation method and application thereof, which has a general chemical formula:

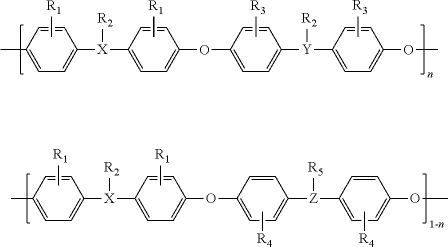

wherein, X is 2 to 5 arylene groups or nitrogen-containing heteroarylene groups; Y is 2 to 5 arylene groups or nitrogen-containing heteroarylene groups, C(CF₃)Ph, C(Ph)₂; Z is direct bond, S, C(CF₃)₂, C₃H₆, SO₂, CO₂, C(CF₃)Ph, C(Ph)₂, 0 to 5 arylene groups or nitrogen-containing heteroarylene groups; R₁ is 0 or more of halogen, NO₂, CN, CF₃, CH₃ or SO₃H; R₂ is 1 to 8 aryl groups or nitrogen-containing heteroaryl groups optionally substituted with 0 to 8 substituents of halogen, NO₂, CN, CF₃, CH₃ or SO₃H; R₃ is 0 to 4 substituents of halogen, NO₂, CN, CF₃, CH₃, SO₃H, aryl or nitrogen-containing heteroaryl; R₄ is 0 or more of halogen, CH₃, NO₂, CN or CF₃, and R₅ is 0 or more of halogen, CH₃, NO₂, CN or CF₃, or 0 to 8 aryl or nitrogen-containing heteroaryl substituted with 0 to 8 substituents of halogen, CH₃, NO₂, CN or CF₃.

Whereby, the polyphenyl polymer has hydrophilic part and dense sulfonic acid side chains, membrane made by the polymer with polyphenyl structure does have strong mechanical properties and maintains good dimensional stability when in contact with water for a long time. Through controlling the polymerization equivalent ratio of Z, the ratio between the hydrophilic and hydrophobic segments can be precisely adjusted.

### FIELD OF THE INVENTION

The present invention relates to sulfonated polyphenylene (phenylene) ether random copolymer, preparation method and application thereof, especially to a polyphenyl polymer having hydrophilic parts and densely packed sulfonic acid side chains, and the ratio between its hydrophilic and hydrophobic segments can be precisely adjusted.

### BACKGROUND OF THE INVENTION

As we known, proton exchange membrane fuel cells mainly use hydrogen as fuel, and only generate water and heat energy after reactions, so they will not cause any pollution to the environment. Therefore, they have gradually become a very important field of energy-related (green energy) technologies valued and competed for development by the industries. Generally speaking, proton exchange membranes belong to solid electrolytes. Although solid electrolytes are different from the conventional voltaic cell's electrolytes form as aqueous solutions, the proton exchange membranes also can be used to transfer positive and negative ions as conductors, just like aqueous solution electrolytes. The function of the proton exchange membranes is mainly for transferring protons. The proton exchange membranes made by polymers are indeed the most important components in the fuel cells, and their properties will affect the performance and life of the fuel cells.

There are many conventional proton exchange membranes in the markets, such as Nafion produced by DuPont. As it is a perfluoro sulfonated polymer, Nafion membrane has high proton conductivity and long service life. However, when the conventional proton exchange membranes in a high temperature and low humidity environment, they cannot effectively retain water molecules, which causes a decrease in proton conductivity. When the glass transition temperature is too low, it cannot continue to work in a high temperature environment, the result is the cost will be higher because it needs to be replaced frequently. Therefore, how to develop a proton exchange membrane technology that can effectively replace conventional proton exchange membranes and at a low price has indeed become a challenge that the industry in the relevant technical field is eager to challenge and overcome.

Prior arts related to the present invention are stated as followings:
first more relevant conventional polymer disclosed in Taiwanese patent application (publication No. TW201700534A which listed in the IDS) is fluorine-containing sulfonated polyaromatic ether polymer with a plurality of repeating units each having following molecular formula:

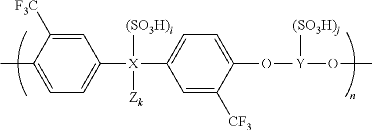

wherein z is independently selected from —F or —CF3 groups; n is an integer greater than or equal to 2; i is an integer from 0 to 10; j is an integer from 1 to 10; and k is an integer from 1 to 6; and
second more relevant conventional polymer disclosed in Taiwanese patent application (publication No. TW202000729A which listed in the IDS) is a cation-containing conductive polymer with a plurality of repeating units each having following general formula:

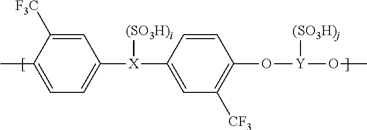

wherein, i is an integer greater than 1 or equal to 1, and j is an integer greater than 1 or equal to 1.

Both of the above-mentioned prior patents disclose that various sulfonated alternating polyaromatic ether copolymers are used for proton exchange membranes. Although the sulfonated alternating polyaromatic ether copolymers have good mechanical and thermal stability, and multiple sulfonation reaction positions can provide higher ion conductivity and maintain excellent dimensional stability. However, polymer of the proton exchange membrane is prepared by adopting post-sulfonation reaction. For adjusting the ion exchange capacity and ion conductivity of the membrane, also taking into account reducing water absorption and ensuring dimensional stability of the membrane, it can only be adjusted through adjusting the ratio of the sulfonating agent and the number of benzene ring substituents. Moreover, the IEC of each batch of polymers produced by post-sulfonation is often inconsistent, fine-tuning and function design of the compound are indeed difficult to achieve, which causes inconvenience and trouble in the application of proton exchange membranes.

### SUMMARY OF THE INVENTION

First main purpose of the present invention is to provide a sulfonated polyphenylene (phenylene) ether random copolymer. The polyphenyl polymer has hydrophilic part and dense sulfonic acid side chains, and in specific part of the polymer has two random segments. One segment of the two random segments has a large number of sulfonate substituents on multiple benzene rings for acting as a hydrophilic segment. The other segment of the two random segments acts as a hydrophobic segment. The ion exchange capacity of the copolymer of the present invention can be adjusted by adjusting the equivalent ratio between the hydrophilic and the hydrophobic segments. The higher the equivalent ratio of the hydrophilic segment, the higher the ion exchange capacity, ion conductivity and water absorption of the film made by the copolymer will be, but the dimensional stability will be worse. The higher the proportion of hydrophobic segment, the lower the ion exchange capacity, ion conductivity and water absorption of the film made by the copolymer will be, but the dimensional stability increases. Moreover, when manufacturing polymer films through the polyphenyl structures of the present invention can impart strong mechanical properties and maintain good dimensional stability when in contact with water for a long time. The technical means copolymer to achieve the main purpose of the present invention has the following general chemical structure of the following formula:

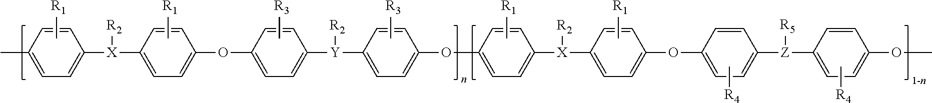

wherein, X is a first linker group optionally substituted 2 to 5 arylene groups or nitrogen-containing heteroarylene groups; Y is a second linker group optionally substituted 2 to 5 arylene groups, nitrogen-containing heteroarylene groups, C(CF₃)Ph groups or C(Ph)₂ groups; R₁ is 0 or an integer number greater than 0 of halogen, NO₂, CN, CF₃, CH₃ or SO₃H; R₂ is 1 to 8 aryl groups or nitrogen-containing heteroaryl groups which optionally substituted with 0 to 8 substituents which independently selected from the groups consisting of halogen, NO₂, CN, CF₃, CH₃ and SO₃H; R₃ is optionally substituted with 0 to 4 substituents which independently selected from halogen, NO₂, CN, CF₃, CH₃, SO₃H, aryl and nitrogen-containing heteroaryl; Z is a direct bond, S, C(CF₃)₂, C₃H₆, SO₂, CO₂, C(CF₃)Ph, C(Ph₂), or a third linker group optionally substituted with 0 to 5 arylene groups or nitrogen-containing heteroarylene groups; wherein, when Z is the direct bond, S, C(CF₃)₂, C₃H₆, SO₂, CO₂, C(CF₃)Ph or C(Ph)₂, R₄ is 0 or an integer number greater than 0 of halogen, CH₃, NO₂, CN or CF₃, and R₅ is 0 or an integer number greater than 0 of halogen, CH₃, NO₂, CN or CF₃; wherein, when Z is the third linker group of 0 to 5 arylene groups or nitrogen-containing heteroarylene groups, R₄ is 1 or an integer number greater than 1 of halogen, CH₃, NO₂, CN or CF₃, and R₅ is 0 to 8 aryl groups or nitrogen-containing heteroarylene groups which optionally substituted with 0 to 8 substituents which are independently selected from the groups consisting of halogen, CH₃, NO₂, CN and CF₃, the repeating unit with the repeating number of n greater than 0 in the formula of the sulfonated polyphenylene (phenylene) ether random copolymer is acting as the hydrophilic segment, and the repeating unit with the repeating number of 1-n in the formula of the sulfonated polyphenylene (phenylene) ether random copolymer is acting as the hydrophobic segment. Moreover, through controlling the polymerization equivalent ratio of Z, the weight ratio between the hydrophilic segment and the hydrophobic segment can be precisely adjusted.

Second main purpose of the present invention is to provide a method for preparing the sulfonated polyphenylene (phenylene) ether random copolymer as mentioned in the first main purpose. The method comprises the steps of: reacting three different polyphenyl ring monomers x, y and z through a randomly polymerization reaction to obtain the polymer with three different polyphenyl ring segments X, Y, and Z, and sulfonating the polymer by a subsequent sulfonation reaction to obtain the sulfonated polyphenylene (phenylene) ether random copolymer, so that the sulfonated polyphenylene (phenylene) ether random copolymer has the general chemical formula structure as mentioned in the first main purpose. Through controlling the polymerization equivalent ratio of olyphenyl ring segment Z or polyphenyl ring monomer z, the weight ratio between the hydrophilic segment and the hydrophobic segment can be precisely adjusted.

Third main purpose of the present invention is to provide applications by the sulfonated polyphenylene (phenylene) ether random copolymer as mentioned in the first main purpose. The applications are mainly to make products as coating solution, proton exchange membrane and electrode by the sulfonated polyphenylene (phenylene) ether random copolymer as mentioned in the first main purpose. Those products are applied to hydrogen fuel cells, direct methanol fuel cells, water electrolysis membranes, vanadium liquid flow cells or membrane electrodes, and those products contain the sulfonated polyphenylene (phenylene) ether random copolymer having the general chemical formula structure as mentioned in the first main purpose.

### BRIEF DESCRIPTION OF THE DRAWINGS

FIG. 1 is a schematic diagram of the sulfonation process for preparing sulfonated polyphenylene (phenylene) ether random copolymers according with the present invention.

### DETAILED DESCRIPTION OF THE PREFERRED EMBODIMENT

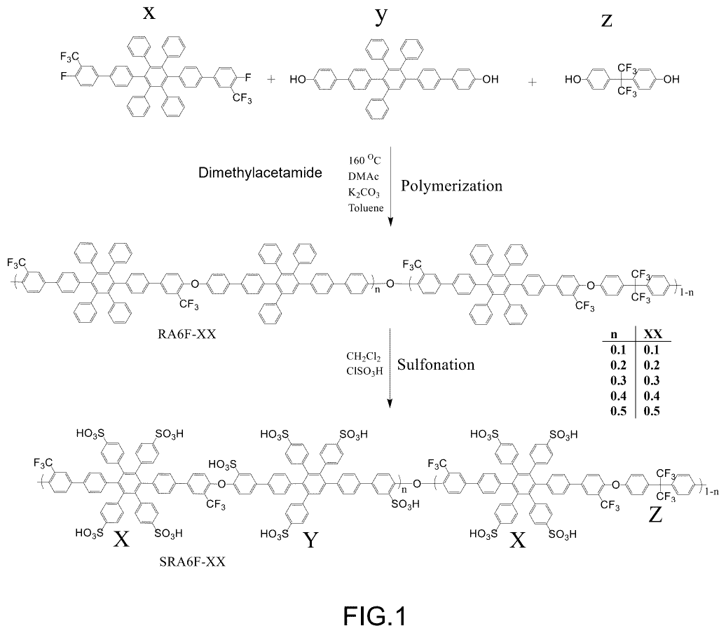

Referring to FIG. 1, One embodiment of the sulfonated poly(phenylene) ether random copolymer structure to achieve the main purpose of the present invention has the following general chemical structure of the following formula:

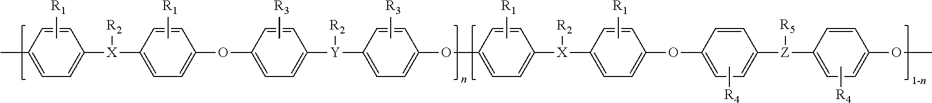

wherein, X is a first linker group optionally substituted with 2 to 5 arylene groups or nitrogen-containing heteroarylene groups; Y is a second linker group optionally substituted with 2 to 5 arylene groups, nitrogen-containing heteroarylene groups, C(CF₃)Ph groups or C(Ph)₂ groups; R₁ represents 0 or an integer number greater than 0 of halogen, NO₂, CN, CF₃, SO₃H, CH₃, alkyl group, per-polyfluoroalkyl substance (PFAS) group or aromatic group, and in one preferable embodiment, wherein the aromatic group contains 1 to 8 aryl groups or nitrogen-containing heteroaryl groups which optionally substituted with 0 to 8 substituents which are independently selected from the groups consisting of halogen, NO₂, CN, CF₃, CH₃, SO₃H, alkyl group, per-polyfluoroalkyl substance (PFAS) group and aromatic group; R₂ represents 1 to 8 aryl groups or nitrogen-containing heteroaryl groups which optionally substituted with 0 to 8 substituents which are independently selected from the groups consisting of halogen, NO₂, CN, CF₃, CH₃, SO₃H, alkyl group, per-poly fluoroalkyl group (PFAS) and aromatic group, and in one preferable embodiment, wherein the aromatic group contains 1 to 8 aryl groups or nitrogen-containing heteroaryl groups which optionally substituted with 0 to 8 substituents which are independently selected from the groups consisting of halogen, NO₂, CN, CF₃, CH₃ and SO₃H; R₃ is optionally substituted with 0 to 4 substituents which are independently selected from halogen, NO₂, CN, CF₃, CH₃, SO₃H, aryl and nitrogen-containing heteroaryl; Z is a direct bond, S, C(CF₃)₂, C₃H₆, SO₂, CO₂, C(CF₃)Ph, C(Ph₂), or a third linker group optionally substituted with 0 to 5 arylene groups or nitrogen-containing heteroarylene groups; wherein, when Z is the direct bond, S, C(CF₃)₂, C₃H₆, SO₂, CO₂, C(CF₃)Ph or C(Ph)₂, R₄ represents 0 or an integer number greater than 0 of halogen, CH₃, NO₂, CN, CF₃, alkyl group, per-poly fluoroalkyl group (PFAS) or aromatic group, wherein the aromatic group contains 1 to 8 aryl groups or nitrogen-containing heteroaryl groups which optionally substituted with 0 to 8 substituents which are independently selected from the groups consisting of halogen, NO₂, CN, CF₃ and CH₃, and R₅ represents 0 or an integer number greater than 0 of halogen, CH₃, NO₂, CN or CF₃; wherein, when Z is the third linker group having 0 to 5 arylene groups or nitrogen-containing heteroarylene groups, R₄ represents 1 or an integer number greater than 1 of halogen, CH₃, NO₂, CN, CF₃, alkyl group, per-polyfluoroalkyl substance (PFAS) group or aromatic group, wherein the aromatic group contains 1 to 8 aryl groups or nitrogen-containing heteroaryl groups which optionally substituted with 0 to 8 substituents which are independently selected from the groups consisting of halogen, NO₂, CN, CF₃ and CH₃, and R₅ represents 0 to 8 aryl groups or nitrogen-containing heteroarylene groups which optionally substituted with 0 to 8 substituents which are independently selected from the groups consisting of halogen, CH₃, NO₂, CN and CF₃, alkyl group and per-polyfluoroalkyl substance (PFAS) group; wherein, the repeating unit with the repeating number of n greater than 0 in the formula of the sulfonated polyphenylene (phenylene) ether random copolymer is acting as a hydrophilic segment, and the repeating unit with the repeating number of 1-n in the formula of the sulfonated polyphenylene (phenylene) ether random copolymer is acting as a hydrophobic segment.

Referring to FIG. 1, the method for preparing a sulfonated poly(phenylene) ether random copolymer is reacting three different polyphenyl ring monomers x, y and z (such as dihalogen monomer and diol monomer) through a nucleophilic polycondensation reaction and a post-sulfonation reaction to prepare the sulfonated polyphenylene (phenylene) ether random copolymer, so that the sulfonated polyphenylene (phenylene) ether random copolymer has the following general chemical formula structure:

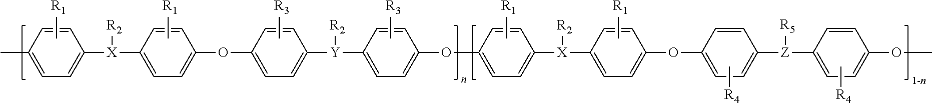

wherein, X is a first linker group optionally substituted with 2 to 5 arylene groups or nitrogen-containing heteroarylene groups; Y is a second linker group optionally substituted with 2 to 5 arylene groups, nitrogen-containing heteroarylene groups, C(CF₃)Ph groups or C(Ph)₂ groups; R₁ represents 0 or an integer number greater than 0 of halogen, NO₂, CN, CF₃, CH₃ or SO₃H; R₂ represents 1 to 8 aryl groups or nitrogen-containing heteroaryl groups which optionally substituted with 0 to 8 substituents which are independently selected from the groups consisting of halogen, NO₂, CN, CF₃, CH₃ and SO₃H; R₃ is optionally substituted with 0 to 4 substituents which are independently selected from halogen, NO₂, CN, CF₃, CH₃, SO₃H, aryl and nitrogen-containing heteroaryl; Z is a direct bond, S, C(CF₃)₂, C₃H₆, SO₂, CO₂, C(CF₃)Ph, C(Ph₂), or a third linker group optionally substituted with 0 to 5 arylene groups or nitrogen-containing heteroarylene groups; wherein, when Z is the direct bond, S, C(CF₃)₂, C₃H₆, SO₂, CO₂, C(CF₃)Ph or C(Ph)₂, R₄ represents 0 or an integer number greater than 0 of halogen, CH₃, NO₂, CN or CF₃, and R₅ represents 0 or an integer number greater than 0 of halogen, CH₃, NO₂, CN or CF₃; wherein, when Z is the third linker group of 0 to 5 arylene groups or nitrogen-containing heteroarylene groups, R₄ represents 1 or an integer number greater than 1 of halogen, CH₃, NO₂, CN or CF₃, and R₅ represents 0 to 8 aryl groups or nitrogen-containing heteroarylene groups and is optionally substituted with 0 to 8 substituents which are independently selected from the groups consisting of halogen, CH₃, NO₂, CN and CF₃; the repeating unit with the repeating number of n greater than 0 (n>0) in the formula of the sulfonated polyphenylene (phenylene) ether random copolymer is acting as a hydrophilic segment, and the repeating unit with the repeating number of 1-n in the formula of the sulfonated polyphenylene (phenylene) ether random copolymer is acting as a hydrophobic segment.

Specifically, as shown in FIG. 1, three different polyphenyl ring segments X, Y, and Z are randomly copolymerized by three polyphenyl ring monomers x, y and z correspondingly to control the position of sulfonation so that the polyphenyl ring segments X and Y can be sulfonated to obtain a hydrophilic segment, and the substituents of R₄ and R₅ on the polyphenyl ring segment Z are unable to be sulfonated or the number of sulfonate groups is reduced so as to form the hydrophobic segments. The weight ratio of the hydrophilic and hydrophobic segments can be finely adjusted by controlling the polymerization equivalent ratio of the polyphenyl ring monomers z.

One application of the present invention is to make products of proton exchange membranes, wherein the sulfonated polyphenylene (phenylene) ether random copolymer is coated to form thin films to be proton exchange membranes, and the proton exchange membranes are applied to hydrogen fuel cells, direct methanol fuel cells, water electrolysis membranes, vanadium liquid flow cells or membrane electrodes.

Another application of the present invention is to make products of solution for coating, wherein the sulfonated polyphenylene (phenylene) ether random copolymer is prepared to be coating solution, and the coating solution is applied to hydrogen fuel cells, direct methanol fuel cells, water electrolysis membranes, vanadium liquid flow cells or membrane electrodes.

Another application of the present invention is to make products of electrodes, wherein the sulfonated polyphenylene (phenylene) ether random copolymer is formed as electrodes, and the electrodes are applied to hydrogen fuel cells, direct methanol fuel cells, water electrolysis membranes, vanadium liquid flow cells or membrane electrodes.

The present invention discloses a novel sulfonated polyphenylene (phenylene) ether random copolymer and a novel method for preparing the same, and the novel sulfonated polyphenylene (phenylene) ether random copolymer can be formed as proton exchange membranes, coating solutions and electrodes for applying to hydrogen fuel cells, direct methanol fuel cells, water electrolysis membranes, vanadium liquid flow cells and membrane electrodes. The present invention is suitable for producing sulfonated polymer compositions and synthetic polymer compositions for use in fuel cells, electrolytic cells, energy storages, dialysis equipment and ultrafiltration, electrodes and membrane electrode assemblies. The sulfonated polyphenylene (phenylene) ether random copolymer of the present invention is designed to be polyphenyl polymer having hydrophilic part and dense sulfonic acid side chain, wherein the specific part of the polymer is substituted with multiple sulfonic acid groups. When made as polymer membranes, the polyphenyl structure can impart strong mechanical properties, especially maintaining good dimensional stability when in contact with water for a long time. The method uses three polyphenyl ring monomers x, y and z to control the position of sulfonation by random copolymerization. The polyphenyl ring segments X and Y can be sulfonated to obtain the hydrophilic segments. The substituents of R₄ and R₅ on the polyphenyl ring segment Z cannot be sulfonated so as to form the hydrophobic segment. By controlling the polymerization equivalent ratio of the chain segment of Z, the ratio between the hydrophilic and hydrophobic segments can be finely adjusted, so that the ion exchange capacity of the sulfonation copolymerization can be more effectively controlled and handled for correctly building different products with different performance levels. By fine-tuning the weight ratio of the hydrophilic segments and hydrophobic segments, the values of IEC of each batch of the polymers produced by post-sulfonation can be controlled in fixed values respectively, so the copolymers have the characteristics of good mechanical properties, excellent film dimensional stabilities, good proton conductivities and controllable ion exchange capacities. For example, when the polyphenyl ring monomer x is dihalogen or diol monomer having an equivalent ratio of 1, the polyphenyl ring monomers y and z are diol or dihalogen monomers and the sum of the equivalent ratio of y and z is also 1; when the polyphenyl ring monomer y is dihalogen or diol monomer and the equivalent ratio is 1, the polyphenyl ring monomers x and z are diol or dihalogen monomers and the sum of the equivalent ratio of x and z is also 1, depending on whether the monomers are dihalogen or diol monomers to be used for the structural design. The equivalent ratios of x, y and z are respectively not equal to 0.

As shown in FIG. 1, the polyphenyl ring monomers x, y, and z can be dihalogen monomers or diol monomers, through nucleophilic polycondensation reaction and post-sulfonation reaction, the sulfonated polyphenylene (phenylene) ether random copolymer can be obtained, if the number of repeating units at the hydrophilic segment is n, then the number of repeating units at the hydrophobic segment is 1-n.

Table 1 is a comparison table of various polymers in terms of equivalent ratios of polyphenyl ring monomers x, y, z, weight average molecular weight (Mw) and dispersity index (PDI) of the polymers according with the present invention.

TABLE 1

| Polymer (sample) | x | y | z | Mw(kDa) | PDI |
|---|---|---|---|---|---|
| RA6F-0.5 | 1 | 0.5 | 0.5 | 198.4 | 2.55 |
| RA6F-0.4 | 1 | 0.4 | 0.6 | 214.7 | 2.34 |
| RA6F-0.3 | 1 | 0.3 | 0.7 | 200.8 | 2.47 |
| RA6F-0.2 | 1 | 0.2 | 0.8 | 221.1 | 2.15 |
| RA6F-0.1 | 1 | 0.1 | 0.9 | 230.6 | 2.82 |

Table 2 is a comparison table of ion exchange capacities (IEC), water absorption rates (Water Uptake) and elongations (ΔL) of various membranes respectively made by the polymers in table 1.

TABLE 2

| Membrane | | Water Uptake (%) | | ΔL(%) | |
|---|---|---|---|---|---|
| (sample) | IEC^{a}(mmol/g) | 30° C. | 80° C. | 30° C. | 80° C. |
| SRA6F-0.5 | 3.46 | 34 | 88 | 15 | 50 |
| SRA6F-0.4 | 3.30 | 31 | 80 | 13 | 46 |
| SRA6F-0.3 | 3.13 | 25 | 64 | 13 | 37 |
| SRA6F-0.2 | 2.95 | 23 | 56 | 11 | 31 |
| SRA6F-0.1 | 2.76 | 20 | 40 | 10 | 26 |

Table 3 is a comparison table of the thermal cracking temperature (T_{d}), Young's modulus (GPa), tensile strength (MPa) and elongation at break of various membranes according with the present invention corresponding to the samples in tables 1 and 2.

TABLE 3

| | | | Tensile | Elongation |
|---|---|---|---|---|
| Membrane | T_{d} 5% | Young's | Strength | at break |
| (sample) | (° C.) | Modulus (GPa) | (MPa) | (%) |
| RA6F-0.5 | 576 | 1.32 | 85.7 | 15 |
| RA6F-0.4 | 570 | 1.12 | 79.8 | 19 |
| RA6F-0.3 | 555 | 0.84 | 66.3 | 27 |
| RA6F-0.2 | 540 | 0.76 | 54.6 | 31 |
| RA6F-0.1 | 531 | 0.70 | 44.2 | 35 |
| SRA6F-0.5 | 245 | 0.75 | 66.2 | 42 |
| SRA6F-0.4 | 247 | 0.64 | 57.2 | 57 |
| SRA6F-0.3 | 249 | 0.48 | 50.4 | 77 |
| SRA6F-0.2 | 250 | 0.42 | 43.1 | 88 |
| SRA6F-0.1 | 252 | 0.38 | 30.5 | 102 |

Table 4 is a comparison table of the proton conductivity of Nafion 211 Membrane with respect to various sulfonated polymer Membranes according with the present invention corresponding to the samples in table 2.

TABLE 4

| | |
|---|---|
| Sulfonated Polymer | Proton conductivity (80° C.)(mS/cm) |

| sample) | 40% | 60% | 80% | 95% |
|---|---|---|---|---|
| SRA6F-0.5 | 27 | 88 | 170 | 201 |
| SRA6F-0.4 | 24 | 83 | 163 | 190 |
| SRA6F-0.3 | 22 | 75 | 154 | 177 |
| SRA6F-0.2 | 20 | 67 | 142 | 166 |
| SRA6F-0.1 | 17 | 58 | 130 | 155 |
| Nafion 211 | 20 | 40 | 90 | 90 |

Table 5 is a comparison table of the proton conductivity of SP1 with respect to various sulfonated polymers according with the present invention corresponding to the samples in table 2. Table 5 shows that the efficiency of samples SRA6F-0.4 (IEC=3.3 mmol/g, 190 mS/cm), SRA6F-0.3 (IEC=3.13 mmol/g, 177 mS/cm) and SRA6F-0.5 (IEC=3.46 mmol/g, 201 mS/cm) are all better than that of the control group SP1 (IEC=3.27 mmol/g, 172 mS/cm). The efficiency of samples SRA6F-0.2 (IEC=2.95 mmol/g, 166 mS/cm) and SRA6F-0.1 (IEC=2.76 mmol/g, 155 mS/cm) is slightly lower than that of the control group SP1 due to their low conductivity. This proves that the present invention uses three polyphenyl ring monomers x, y, and z with different structures to form the sulfonated polyphenylene (phenylene) ether random copolymer through nucleophilic polycondensation reaction and regulates the polymerization ratios of the monomers. After the sulfonation reaction, a certain polymer with a specific controlled ratio of hydrophilic and hydrophobic segments is formed. By regulating the polymerization ratio, the hydrophilic and hydrophobic segments of the polymer can be effectively fine-tuned/controlled, so that the polymer of the present invention in the implementation case can have a higher conductivity when the IEC is similar to that of the control group SP1, and the efficiency of the fuel cell is about 10% higher than that of the control group.

TABLE 5

| | | | Power Density |
|---|---|---|---|
| Sample | Voltage(V) | Current(mA/cm²) | (mW/cm²) |
| SRA6F-0.5 | 0.4256 | 2800 | 1191.8 |
| SRA6F-0.4 | 0.4111 | 2800 | 1151.1 |
| SRA6F-0.3 | 0.4066 | 2800 | 1138.6 |
| SRA6F-0.2 | 0.4120 | 2600 | 1071.2 |
| SRA6F-0.1 | 0.3830 | 2400 | 919.3 |
| SP1 | 0.4042 | 2800 | 1130.2 |

Therefore, through the detailed description of the above specific embodiments, the present invention does have the following advantages: a) The present invention can indeed prepare a polyphenyl polymer having a hydrophilic part and dense sulfonic acid side chains, and multiple sulfonic acid groups are substituted in a specific part of the polymer, when the polyphenyl polymer is made into a polymer membrane, the polyphenyl structure can indeed impart strong mechanical properties and maintain good dimensional stability when in contact with water for a long time; b) the sulfonated polyphenylene (phenylene) ether random copolymer prepared by the present invention can indeed be used as the materials for producing proton exchange membranes, and based on the method of the present invention to prepare the above-mentioned sulfonated polyphenylene (phenylene) ether random copolymer, and according to the above-mentioned characteristics of the sulfonated polyphenylene ionomer, the proton exchange membranes have low cost and can be effectively controlled their ion exchange capacity, so it has a good application prospect in electrochemical energy conversion devices, such as fuel cells, water electrolysis membranes, and liquid flow cells; c) the novel sulfonated polyphenylene (phenylene) ether random copolymers of the present invention, and preparation method thereof, can be prepared as products as proton exchange membranes (PEMs), coating solutions and electrodes for applying to hydrogen fuel cells, direct methanol fuel cells and membrane electrodes, and d) the method of the present invention is suitable for producing sulfonated polymer compositions and synthetic polymer composition for applying to polymer electrolyte membranes, electrodes and membrane electrode assemblies of fuel cells, electrolytic cells, and electrolyte membranes for dialysis and ultrafiltration equipment.

While we have shown and described the embodiment in accordance with the present invention, it should be clear to those skilled in the art that further embodiments may be made without departing from the scope of the present invention.

What is claimed is:

1. A sulfonated polyphenylene (phenylene) ether random copolymer having a general chemical structure of the following formula: 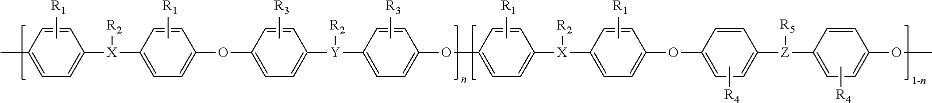
wherein, X is a first linker group optionally substituted with 2 to 5 arylene groups or nitrogen-containing heteroarylene groups; Y is a second linker group optionally substituted with 2 to 5 arylene groups, nitrogen-containing heteroarylene groups, C(CF₃)Ph groups or C(Ph)₂ groups; R₁ represents 0 or an integer number greater than 0 of halogen, NO₂, CN, CF₃, CH₃ or SO₃H; R₂ represents 1 to 8 aryl groups or nitrogen-containing heteroaryl groups which optionally substituted with 0 to 8 substituents which are independently selected from the groups consisting of halogen, NO₂, CN, CF₃, CH₃ and SO₃H; R₃ is optionally substituted with 0 to 4 substituents which are independently selected from halogen, NO₂, CN, CF₃, CH₃, SO₃H, aryl and nitrogen-containing heteroaryl; Z is a direct bond, S, C(CF₃)₂, C₃H₆, SO₂, CO₂, C(CF₃)Ph, C(Ph₂), 0 to 5 arylene groups or nitrogen-containing heteroarylene groups; wherein, when Z is the direct bond, S, C(CF₃)₂, C₃H₆, SO₂, CO₂, C(CF₃)Ph or C(Ph)₂, R₄ is 0 or an integer number greater than 0 of halogen, CH₃, NO₂, CN or CF₃, and R₅ is 0 or an integer number greater than 0 of halogen, CH₃, NO₂, CN or CF₃; wherein, when Z is 0 to 5 arylene groups or nitrogen-containing heteroarylene groups, R₄ is 1 or an integer number greater than 1 of halogen, CH₃, NO₂, CN or CF₃, and R₅ is 0 to 8 aryl groups or nitrogen-containing heteroarylene groups which optionally substituted with 0 to 8 substituents which are independently selected from the groups consisting of halogen, CH₃, NO₂, CN and CF₃; the repeating unit with the repeating number of n greater than 0 in the formula of the sulfonated polyphenylene (phenylene) ether random copolymer is acting as a hydrophilic segment, and the repeating unit with the repeating number of 1-n in the formula of the sulfonated polyphenylene (phenylene) ether random copolymer is acting as a hydrophobic segment.

2. The sulfonated polyphenylene (phenylene) ether random copolymer as claimed in claim 1, wherein R₁ and R₄ further respectively represent 0 or an integer number greater than 0 of alkyl group, per-polyfluoroalkyl substance (PFAS) group and aromatic group; the substituents of R₂, R₃ and R₅ are further independently selected from the groups consisting of alkyl groups, per-polyfluoroalkyl substance (PFAS) groups and aromatic groups.

3. The sulfonated polyphenylene (phenylene) ether random copolymer as claimed in claim 2, wherein the aromatic groups of R₁, R₂ and R₃ respectively contain 1 to 8 aryl groups or nitrogen-containing heteroaryl groups which optionally substituted with 0 to 8 substituents which are independently selected from the groups consisting of halogen, NO₂, CN, CF₃, CH₃ and SO₃H; wherein the aromatic groups of R₄ and R₅ respectively contain 1 to 8 aryl groups or nitrogen-containing heteroaryl groups which optionally substituted with 0 to 8 substituents which are independently selected from the groups consisting of halogen, NO₂, CN, CF₃ and CH₃.

4. The sulfonated polyphenylene (phenylene) ether random copolymer as claimed in claim 1, wherein through a nucleophilic polycondensation reaction, X, Y and Z are formed by polyphenyl ring monomers x, y and z correspondingly; wherein, when x is a dihalogen or diol monomer having an equivalent ratio of 1, y and z are diol or dihalogen monomers and a sum of equivalent ratios of y and z is 1; wherein, when y is a dihalogen or diol monomer having an equivalent ratio of 1, x and z are diol or dihalogen monomers and a sum of equivalent ratios of x and z is 1; the equivalent ratios of x, y and z are respectively not equal to 0.

5. The sulfonated polyphenylene (phenylene) ether random copolymer as claimed in claim 4, wherein a weight ratio between the hydrophilic and hydrophobic segments is adjustable by controlling the equivalent ratio of z.

6. A method for preparing the sulfonated polyphenylene (phenylene) ether random copolymer as claimed in claim 1 comprised the steps of:
treating three polyphenyl ring monomers x, y and z by a nucleophilic polycondensation reaction to obtain polyphenyl ring segments of X, Y and Z correspondingly; wherein, when the polyphenyl ring monomer x is a dihalogen or diol monomer having an equivalent ratio of 1, the polyphenyl ring monomers y and z are diol or dihalogen monomers and a sum of equivalent ratios of y and z is 1; wherein, when the polyphenyl ring monomer y is a dihalogen or diol monomer having an equivalent ratio of 1, the polyphenyl ring monomers x and z are diol or dihalogen monomers and a sum of equivalent ratios of x and z is 1, and
then through a post-sulfonation reaction to obtain the sulfonated polyphenylene (phenylene) ether random copolymer having a general chemical structure of the following formula: 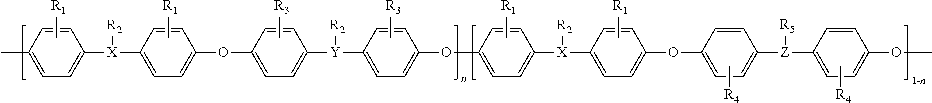
wherein, X is a first linker group optionally substituted with 2 to 5 arylene groups or nitrogen-containing heteroarylene groups; Y is a second linker group optionally substituted with 2 to 5 arylene groups, nitrogen-containing heteroarylene groups, C(CF₃)Ph groups or C(Ph)₂ groups; R₁ represents 0 or an integer number greater than 0 of halogen, NO₂, CN, CF₃, CH₃ or SO₃H; R₂ represents 1 to 8 aryl groups or nitrogen-containing heteroaryl groups which optionally substituted with 0 to 8 substituents which are independently selected from the groups consisting of halogen, NO₂, CN, CF₃, CH₃ and SO₃H; R₃ is optionally substituted with 0 to 4 substituents which are independently selected from halogen, NO₂, CN, CF₃, CH₃, SO₃H, aryl and nitrogen-containing heteroaryl; Z is a direct bond, S, C(CF₃)₂, C₃H₆, SO₂, CO₂, C(CF₃)Ph, C(Ph₂), or a third linker group optionally substituted with 0 to 5 arylene groups or nitrogen-containing heteroarylene groups; wherein, when Z is the direct bond, S, C(CF₃)₂, C₃H₆, SO₂, CO₂, C(CF₃)Ph or C(Ph)₂, R₄ is 0 or an integer number greater than 0 of halogen, CH₃, NO₂, CN or CF₃, and R₅ is 0 or an integer number greater than 0 of halogen, CH₃, NO₂, CN or CF₃; wherein, when Z is the third linker group of 0 to 5 arylene groups or nitrogen-containing heteroarylene groups, R₄ is 1 or an integer number greater than 1 of halogen, CH₃, NO₂, CN or CF₃, and R₅ is 0 to 8 aryl groups or nitrogen-containing heteroarylene groups which optionally substituted with 0 to 8 substituents which are independently selected from the groups consisting of halogen, CH₃, NO₂, CN and CF₃; the repeating unit with the repeating number of n greater than 0 in the formula of the sulfonated polyphenylene (phenylene) ether random copolymer is acting as a hydrophilic segment, and the repeating unit with the repeating number of 1-n in the formula of the sulfonated polyphenylene (phenylene) ether random copolymer is acting as a hydrophobic segment.

7. The method as claimed in claim 6, wherein R₁ and R₄ further respectively represent 0 or an integer number greater than 0 of alkyl group, per-polyfluoroalkyl substance (PFAS) group and aromatic group; the substituents of R₂, R₃ and R₅ are further independently selected from the groups consisting of alkyl groups, per-polyfluoroalkyl substance (PFAS) groups and aromatic groups.

8. The method as claimed in claim 7, wherein the aromatic groups of R₁, R₂ and R₃ respectively contain 1 to 8 aryl groups or nitrogen-containing heteroaryl groups which optionally substituted with 0 to 8 substituents which are independently selected from the groups consisting of halogen, NO₂, CN, CF₃, CH₃ and SO₃H; wherein the aromatic groups of R₄ and R₅ respectively contain 1 to 8 aryl groups or nitrogen-containing heteroaryl groups which optionally substituted with 0 to 8 substituents which are independently selected from the groups consisting of halogen, NO₂, CN, CF₃ and CH₃.

9. The method as claimed in claim 6, wherein the polyphenyl ring segments of X, Y, and Z are randomly copolymerized through the nucleophilic polycondensation reaction to control the post-sulfonation reaction so that the polyphenyl ring segments X and Y are sulfonated to form the hydrophilic segment, the substituents of R₄ and R₅ on the polyphenyl ring segment Z cannot be sulfonated so as to form the hydrophobic segment; wherein, by controlling the equivalent ratio of the polyphenyl ring monomer z, an weight ratio between the hydrophilic and hydrophobic segments is adjusted.

10. The method as claimed in claim 6, wherein a weight ratio between the hydrophilic and hydrophobic segments is adjustable by controlling the equivalent ratio of the polyphenyl ring monomer z; and the equivalent ratios of x, y and z are respectively not equal to 0.

11. A product made by the sulfonated polyphenylene (phenylene) ether random copolymer as claimed in claim 1, the product is formed by the sulfonated polyphenylene (phenylene) ether random copolymer to be proton exchange membranes, coating solutions or electrodes to be applied to hydrogen fuel cells, direct methanol fuel cells, water electrolysis membranes, vanadium liquid flow cells or membrane electrodes.

12. The product as claimed in claim 11, wherein, in the general chemical structure of the formula of the sulfonated polyphenylene (phenylene) ether random copolymer, wherein R₁ and R₄ further respectively represent 0 or an integer number greater than 0 of alkyl group, per-polyfluoroalkyl substance (PFAS) group and aromatic group; the substituents of R₂, R₃ and R₅ are further independently selected from the groups consisting of alkyl groups, per-polyfluoroalkyl substance (PFAS) groups and aromatic groups.

13. The product as claimed in claim 12, wherein the aromatic groups of R₁, R₂ and R₃ respectively contain 1 to 8 aryl groups or nitrogen-containing heteroaryl groups which optionally substituted with 0 to 8 substituents which are independently selected from the groups consisting of halogen, NO₂, CN, CF₃, CH₃ and SO₃H; wherein the aromatic groups of R₄ and R₅ respectively contain 1 to 8 aryl groups or nitrogen-containing heteroaryl groups which optionally substituted with 0 to 8 substituents which are independently selected from the groups consisting of halogen, NO₂, CN, CF₃ and CH₃.

14. The product as claimed in claim 11, wherein, in the general chemical structure of the formula of the sulfonated polyphenylene (phenylene) ether random copolymer, through a nucleophilic polycondensation reaction, X, Y and Z are formed by polyphenyl ring monomers x, y and z correspondingly; wherein, when x is a dihalogen or diol monomer having an equivalent ratio of 1, y and z are diol or dihalogen monomers and a sum of equivalent ratios of y and z is 1; wherein, when y is a dihalogen or diol monomer having an equivalent ratio of 1, x and z are diol or dihalogen monomers and a sum of equivalent ratios of x and z is 1; the equivalent ratios of x, y and z are respectively not equal to 0.

15. The product as claimed in claim 14, wherein a weight ratio between the hydrophilic and hydrophobic segments of the sulfonated polyphenylene (phenylene) ether random copolymer is adjustable by controlling the equivalent ratio of the polyphenyl ring monomer z.
